(19) United States
(12) Patent Application Publication
(10) Pub. No.: US 2024/0375552 A1
(43) Pub. Date: Nov. 14, 2024

(54) SEAT CONTROL APPARATUS AND SEAT CONTROL METHOD

(71) Applicants: HYUNDAI MOTOR COMPANY, Seoul (KR); KIA CORPORATION, Seoul (KR)

(72) Inventors: Kug Hun Han, Seoul (KR); Mun Seung Kang, Suwon-si (KR); Yo Han Kim, Ansan-si (KR); Dong Hoon Lee, Hwaseong-si (KR)

(73) Assignees: HYUNDAI MOTOR COMPANY, Seoul (KR); KIA CORPORATION, Seoul (KR)

(21) Appl. No.: 18/653,680

(22) Filed: May 2, 2024

(30) Foreign Application Priority Data
May 14, 2023 (KR) 10-2023-0062088
Aug. 24, 2023 (KR) 10-2023-0111404

(51) Int. Cl. B60N 2/02

(52) U.S. Cl. CPC B60N 2/0252; B60N 2/02246; B60N 2/0248

(57) ABSTRACT

A seat control apparatus may receive a switch input regarding a target mode. The switch input may be provided by a user through an input part. The seat control apparatus may identify a previous operation mode of the seat. The seat control apparatus may determine, based on the previous operation mode, one of the target mode and a restoring mode as a specific operation mode. The seat control apparatus may control a location of the seat by using the driving part such that the location of the seat corresponds to the specific operation mode. The seat control apparatus may also renew an operation mode of the seat the specific operation mode and store the renewed operation mode in the memory.

### CROSS-REFERENCE TO RELATED APPLICATION

This application claims the benefit of and priority to Korean Provisional Application No. 10-2023-0062088, filed in the Korean Intellectual Property Office on May 14, 2023, and Korean Patent Application No. 10-2023-0111404, filed in the Korean Intellectual Property Office on Aug. 24, 2023. The entire contents of both prior filed applications are incorporated herein by reference.

### TECHNICAL FIELD

The present disclosure relates generally to a seat control apparatus and a seat control method. More particularly, the present disclosure relates to a technology for controlling a location of a seat based on a received switch input.

### BACKGROUND

With the development of technologies, various components may be operatively connected to each other in an interior of a vehicle. In particular, a seat control apparatus may perform a cooperative control of components for convenience of a user to promptly and accurately provide various functions.

For example, a vehicle may include a seat control apparatus that controls locations of a plurality of seats. The seat control apparatus may control a location of a seat by adjusting at least one of a backrest angle (or a reclining angle), a cushion height, a tilting angle (or an angle of a cushion), a leg rest angle, or a slide location of the seat, or any combination thereof, to control the location (or an operation mode) of the seat.

In particular, with the development of the technologies, a seat control apparatus may perform a control of a location of a seat based on a fully automatic scheme by using at least one motor. For example, the seat control apparatus may adjust an angle of a backrest of a seat by using a recliner that is disposed in one area of the seat and includes at least one motor. Similarly, the seat control apparatus may adjust at least one of a backrest angle, a cushion height, a tilting angle, a leg rest angle, or a slide location of the seat, or any combination thereof, by using at least one driving part including at least one motor.

Generally, at least one switch that receives an input by a user may be necessary to implement a control of a location of a seat by a fully automatic scheme. However, there is a limitation in minimizing or reducing the number of switches due to lack of mounting spaces and limitations in a space of the seat.

Accordingly, schemes have been developed to minimize the number of switches by mounting an automatic switch (or a one touch button) and controlling a location of a seat to an operation state corresponding to the automatic switch when a user input to the automatic switch is received. The switch may be implemented such that the seat is restored to an original state when a user input is received again.

However, in a control of a location of a seat in a fully automatic scheme, when the location control is stopped due to several situations while the seat is shifted to an operation state corresponding to an automatic switch or a user requires any one operation state between the corresponding operation state and a restoring state, it is difficult to perform the location control properly.

Moreover, in a process of operating the seat in the target mode (e.g., a walk-in mode) based on a control of a location of the seat in a fully automatic manner, the control of the location of the seat may be stopped due to an inevitable situation when the seat is not perfectly adjusted to correspond to the target mode. In this case, a clear reference for which operation mode the location of the seat has to be controlled based on when the seat control apparatus receives a switch input from the user again after the seat is stopped may not be present. Accordingly, the user that requires the control of the location of the seat may be confused.

### SUMMARY

The present disclosure has been made to solve the above-mentioned problems occurring in the prior art while advantages achieved by the prior art are maintained intact.

An aspect of the present disclosure provides a seat control apparatus that, when receiving a user input regarding a target mode (e.g., a walk-in mode) through an input part, identifies a previous operation mode of a seat, which was operated before the seat receives the user input. The seat control apparatus determines one of a target mode and a restoring mode as a specific operation mode based on the identified previous operation mode. The seat control apparatus controls a location of the seat such that the location corresponds to a specific operation mode by using a driving part. The seat control apparatus renews an operation mode of the seat to the specific operation mode and stores the renewed operation mode in a memory.

An aspect of the present disclosure provides a seat control apparatus that controls an operation mode of a seat by identifying at least one of a tip and slide mode, a walk-in slide mode, a backrest folding mode, a double folding mode, a stand-up mode, or a dive and go mode, or any combination thereof, as a target mode.

An aspect of the present disclosure provides a seat control apparatus that, when receiving a switch input while a seat is controlled in a specific operation mode, variably performs a control of a location of the seat based on a type of a previous operation mode and a setting state regarding a control of the seat.

An aspect of the present disclosure provides a seat control apparatus that, when an operation state of a seat and a state of a host vehicle respectively satisfy specific conditions, performs a control of a location of the seat to different specific operation modes according to an operation situation of the seat based on a received switch input.

An aspect of the present disclosure provides a seat control apparatus that, when a seat is operated in a pre-emptive operation mode of a target mode corresponding to a switch input, continuously performs a control of a location of the seat in the pre-emptive operation mode while neglecting the received switch input.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, a seat control apparatus is provided. The seat control apparatus includes an input part disposed in one area of a seat. The seat control apparatus also includes a driving part that adjusts at least one of a reclining angle, a slide location, or a cushion angle of the seat, or any combination thereof. The seat control apparatus further includes a memory that stores one or more instructions and a controller operatively connected to the input part, the driving part, and the memory. The instructions, when executed by the controller, cause the seat control apparatus to receive a switch input regarding a target mode. The switch input may be provided by a user through the input part. The instructions, when executed by the controller, further cause the seat control apparatus to identify a previous operation mode of the seat. The instructions, when executed by the controller, further still cause the seat control apparatus to determine, based on the previous operating mode, one of the target mode and a restoring mode as a specific operation mode. The instructions, when executed by the controller, further cause the seat control apparatus to control a location of the seat by using the driving part such that the location of the seat corresponds to the specific operation mode. The instructions, when executed by the controller, further yet cause the seat control apparatus to renew an operation mode of the seat to the specific operation mode. The instructions, when executed by the controller, also cause the seat control apparatus to store the renewed operation mode in the memory.

According to an embodiment, the target mode may include at least one of a tip and slide mode, a walk-in slide mode, a backrest folding mode, a double folding mode, a stand-up mode, or a dive and go move, or any combination thereof.

According to an embodiment, the instructions, when executed by the controller, may cause the seat control apparatus to determine the target mode as the specific operation mode when the identified previous operation mode is the restoring mode. The instructions, when executed by the controller, may also cause the seat control apparatus to control the location of the seat such that the location of the seat corresponds to the target mode, renew the operation mode of the seat to the target mode, and store the renewed operation mode in the memory.

According to an embodiment, the instructions, when executed by the controller, may cause the seat control apparatus to determine the restoring mode as the specific operation mode when the identified previous operation mode is the target mode. The instructions, when executed by the controller, may also cause the seat control apparatus to control the location of the seat such that the location of the seat corresponds to the restoring mode, renew the operation mode of the seat to the restoring mode, and store the renewed operation mode in the memory.

According to an embodiment, the instructions, when executed by the controller, may cause the seat control apparatus to identify a reference operation mode corresponding to a case in which i) the previous operation mode is set to a stop mode and ii) the switch input is received when the seat is in a stop state and the identified previous operation mode is the stop mode when the switch input is received. The instructions, when executed by the controller, may also cause the seat control apparatus to control the location of the seat such that the location of the seat corresponds to the reference operation mode, renew the operation mode of the seat to the reference operation mode, and store the renewed operation mode in the memory.

According to an embodiment, the instructions, when executed by the controller, may further cause the seat control apparatus to identify whether the seat is operated in the target mode or the restoring mode when the switch input is received. The instructions, when executed by the controller, may also cause the seat control apparatus to stop an operation of the seat, renew the operation mode of the seat to a stop mode when the seat is stopped, and store the renewed operation mode in the memory when the seat is operated in the target mode or the restoring mode.

According to an embodiment, the instructions, when executed by the controller, may cause the seat control apparatus to identify an operation state of the seat and a state of a host vehicle when the switch input is received. The instructions, when executed by the controller, may further cause the seat control apparatus to identify whether the seat is operated in the target mode or the restoring mode when the operation state of the seat satisfies a first condition and the state of the host vehicle satisfies a second condition. The instructions, when executed by the controller, may cause the seat control apparatus to stop an operation of the seat, renew the operation mode of the seat to a stop mode when the seat is stopped, and store the renewed operation mode in the memory when the seat is operated in the target mode or the restoring mode.

According to an embodiment, the instructions, when executed by the controller, may further cause the seat control apparatus to identify whether the seat is operated in the target mode or the restoring mode when the operation state of the seat satisfies the first condition and the state of the host vehicle satisfies the second condition. The instructions, when executed by the controller, may also cause the seat control apparatus to determine one of the target mode and the restoring mode as the specific operation mode based on the previous operation mode when the seat is operated in a post-emptive operation mode of the target mode and the restoring mode or is not operated. The instructions, when executed by the controller, may further cause the seat control apparatus to control the location of the seat such that the location of the seat corresponds to the specific operation mode, renew the operation mode of the seat to the specific operation mode, and store the renewed operation mode in the memory.

According to an embodiment, the instructions, when executed by the controller, may cause the seat control apparatus to determine that the operation mode of the seat does not satisfy the first condition when the seat is operated in a pre-emptive operation mode of the target mode and the restoring mode. The instructions, when executed by the controller, may also cause the seat control apparatus to control the location of the seat continuously in the pre-emptive operation mode while neglecting the switch input.

According to an embodiment, the instructions, when executed by the controller, may cause the seat control apparatus to determine that the state of the host vehicle does not satisfy the second condition when a door corresponding to the seat is closed, a safety belt of the seat is in a fastened state, a passenger is seated on the seat, a gearshift of the host vehicle is not set to stage “P”, or a travel speed of the host vehicle is more than a specific speed. The instructions, when executed by the controller, may also cause the seat control apparatus to neglect the switch input and stop controlling the location of the seat.

According to another aspect of the present disclosure, a seat control method is provided. The seat control method includes receiving, by a controller, a switch input regarding a target mode. The switch input may be provided by a user through an input part. The seat control method may also include identifying, by the controller, a previous operation mode of a seat. The seat control method may additionally include determining, by the controller based on the previous operation mode, one of the target mode and/or a restoring mode as a specific operation mode. The seat control method may additionally include controlling, by the controller, a location of the seat by using a driving part such that the location of the seat corresponds to the specific operation mode. The seat control method may further include renewing an operation mode of the seat to the specific operation mode. The seat control method may further still include storing the renewed operation mode in a memory.

According to an embodiment, the target mode may include at least one of a tip and slide mode, a walk-in slide mode, a backrest folding mode, a double folding mode, a stand-up mode, or a dive and go move, or any combination thereof.

According to an embodiment, the seat control method may include determining, by the controller, the target mode as the specific operation mode when the identified previous operation mode is the restoring mode. The seat control method may additionally include controlling, by the controller, the location of the seat such that the location of the seat corresponds to the target mode, renewing the operation mode of the seat to the target mode, and storing the renewed operation mode in the memory.

According to an embodiment, the seat control method may include determining, by the controller, the restoring mode as the specific operation mode when the identified previous operation mode is the target mode. The seat control method may additionally include controlling, by the controller, the location of the seat such that the location of the seat corresponds to the restoring mode, renewing the operation mode of the seat to the restoring mode, and storing the renewed operation mode in the memory.

According to an embodiment, the seat control method may further include identifying, by the controller, a reference operation mode corresponding to a case in which i) the previous operation mode is set to a stop mode and ii) the switch input is received when the seat is in a stop state and the identified previous operation mode is the stop mode when the switch input is received. The seat control method may also include controlling, by the controller, the location of the seat such that the location of the seat corresponds to the reference operation mode, renewing the operation mode of the seat to the reference operation mode, and storing the renewed operation mode in the memory.

According to an embodiment, the seat control method may further include identifying, by the controller, whether the seat is operated in the target mode or the restoring mode when the switch input is received. The seat control method may additionally include, when the seat is operated in the target mode or the restoring mode stopping, by the controller, an operation of the seat, renewing the operation mode of the seat to a stop mode when the seat is stopped, and storing the renewed operation mode in the memory.

According to an embodiment, the seat control method may further include identifying, by the controller, an operation state of the seat and a state of a host vehicle when the switch input is received. The seat control method may also include identifying, by the controller, whether the seat is operated in the target mode or the restoring mode when the operation state of the seat satisfies a first condition and the state of the host vehicle satisfies a second condition The seat control method may further include, when the seat is operated in the target mode or the restoring mode, stopping, by the controller, an operation of the seat, renewing the operation mode of the seat to a stop mode when the seat is stopped, and storing the renewed operation mode in the memory.

According to an embodiment, the seat control method may further include identifying, by the controller, whether the seat is operated in the target mode or the restoring mode when the operation state of the seat satisfies the first condition and the state of the host vehicle satisfies the second condition. The seat control method may also include determining, by the controller, one of the target mode and the restoring mode as the specific operation mode based on the previous operation mode when the seat is operated in a post-emptive operation mode of the target mode and the restoring mode or is not operated. The seat control method may additionally include controlling, by the controller, the location of the seat such that the location of the seat corresponds to the specific operation mode, renewing the operation mode of the seat to the specific operation mode, and storing the renewed operation mode in the memory.

According to an embodiment, the seat control method may further include determining, by the controller, that the operation mode of the seat does not satisfy the first condition when the seat is operated in a pre-emptive operation mode of the target mode and the restoring mode. The seat control method may also include controlling, by the controller, the location of the seat continuously in the pre-emptive operation mode while neglecting the switch input.

According to an embodiment, the seat control method may further include determining, by the controller, that the state of the host vehicle does not satisfy the second condition when a door corresponding to the seat is closed, a safety belt of the seat is in a fastened state, a passenger is seated on the seat, a gearshift of the host vehicle is not set to stage “P”, or a travel speed of the host vehicle is more than a specific speed. The seat control method may also include neglecting, by the controller, the switch input and stopping controlling the location of the seat.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram illustrating components of a seat control apparatus, according to an embodiment of the present disclosure;

FIGS. 2A-2E are conceptual views illustrating operation state of a seat through a control by a seat control apparatus, according to embodiments of the present disclosure;

FIGS. 3A and 3B are conceptual views illustrating an input part of a seat control apparatus, according to embodiments of the present disclosure;

FIG. 4 is a block diagram illustrating components of a seat control apparatus, according to an embodiment of the present disclosure;

FIG. 5 is a flowchart of a seat control method, according to an embodiment of the present disclosure;

FIG. 6 is a flowchart of a seat control method, according to another embodiment of the present disclosure;

FIG. 7 is a flowchart of a seat control method, according to yet another embodiment of the present disclosure;

FIG. 8 is a flowchart of a seat control method, according to yet another embodiment of the present disclosure;

FIG. 9 illustrating a computing system that may implement a seat control method, according to an embodiment of the present disclosure.

In relation to the description of the drawings, the same or similar components may be denoted by the same or similar reference numerals.

### DETAILED DESCRIPTION

Hereinafter, embodiments of the present disclosure are described in detail with reference to the accompanying drawings. In adding reference numerals to the components of the drawings, the same components are denoted by the same reference numerals even when the components are shown in different drawings. Furthermore, in describing the embodiments of the present disclosure, where it was determined that a detailed description of related known configurations and functions may hinder understanding of the embodiments of the present disclosure, a detailed description thereof has been omitted.

In describing the components of the embodiments of the present disclosure, terms, such as first, second, “A”, “B”, (a), and (b) may be used. These terms are simply for distinguishing the components. The essence, the sequence, and the order of the corresponding components are not limited by the terms. Furthermore, unless otherwise defined, all terms, including technical and scientific terms, used herein have the same meaning as commonly understood by those having ordinary skill in the art to which the present disclosure pertains. It should be further understood that terms, such as those defined in commonly used dictionaries, should be interpreted as having a meaning that is consistent with their meaning in the context of the specification and relevant art. The terms should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

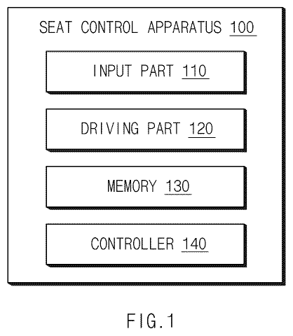

Hereinafter, embodiments of the present disclosure are described with reference to FIGS. 1-9.

FIG. 1 is a block diagram illustrating components of a seat control apparatus, according to an embodiment of the present disclosure.

According to an embodiment, a seat control apparatus 100 may include at least one of an input part 110, a driving part 120, a memory 130, or a controller 140, or any combination thereof. A configuration of the seat control apparatus 100, which is illustrated in FIG. 1, is illustrative. The embodiments of the present disclosure are not limited thereto. For example, the seat control apparatus 100 may further include components (e.g., at least one of a memory, an interface part, a communication part, a display part, or a sensor part, or any combination thereof) that are not illustrated in FIG. 1.

According to an embodiment, the input part 110 may include at least one switch.

For example, the input part 110 may include at least one switch provided in one area of a seat. The one area, as an example, may include one area of a backrest of the seat and/or one area of a side cushion of the seat.

The input part 110 may include a plurality of switches corresponding to at least one type. As an example, the input part 110 may include a plurality of switches of types that are distinguished from each other.

The types of the switch may include an automatic switch and/or a manual switch.

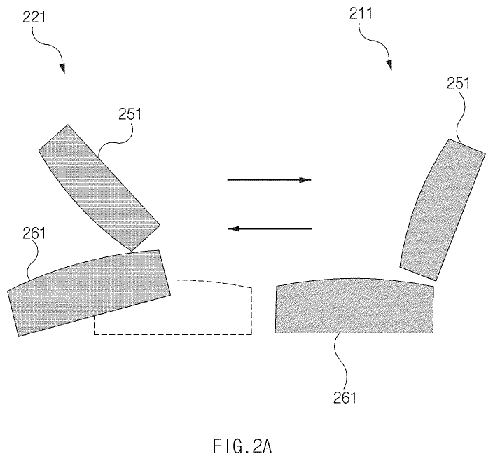

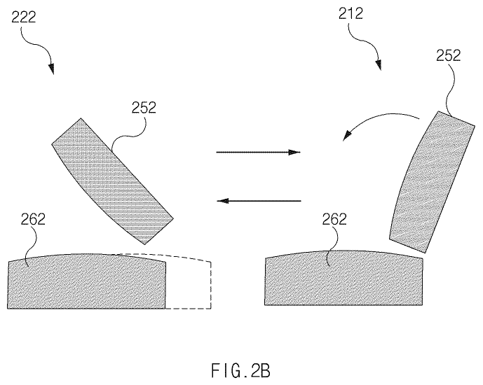

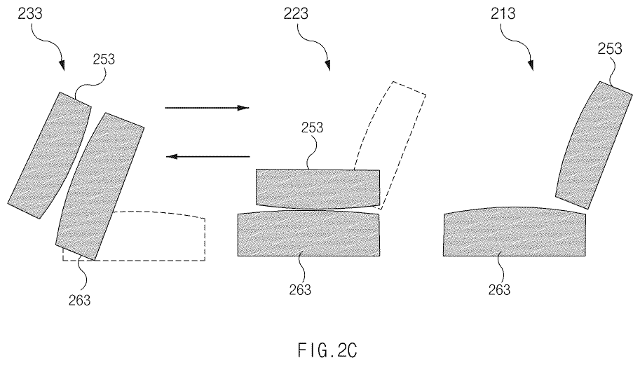

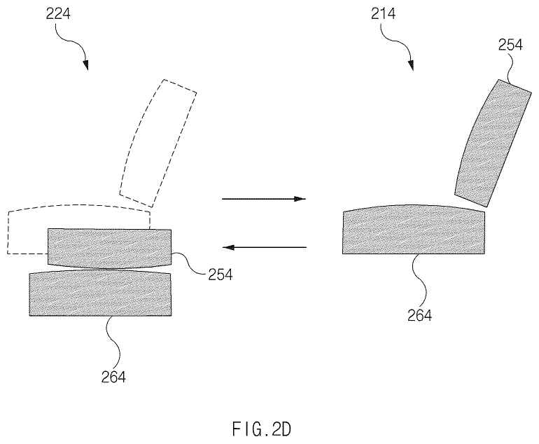

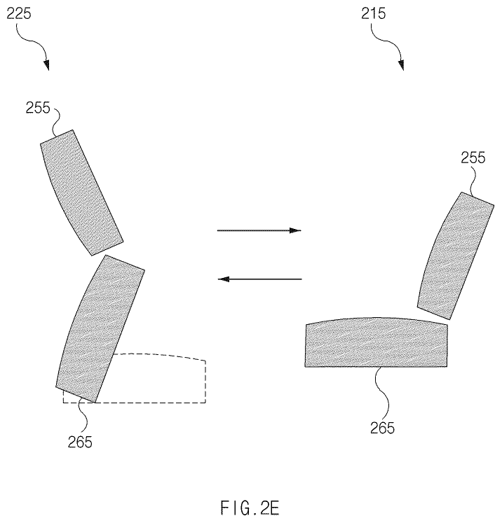

The automatic switch, for example, may include at least one switch (or automatic switch) corresponding to a control function of controlling an operation state of the seat to a target mode (e.g., at least one of a tip and slide mode, a walk-in slide mode, a backrest folding mode, a double folding mode, a stand-up mode, or a dive and go mode, or any combination thereof), or restoring the operation state of the seat to an original state (e.g., a general mode in which a user may be easily seated, as explained in more detail below with reference to FIG. 2A). When a switch input (e.g., a touch input by a user) to the automatic switch is detected, the seat control apparatus 100 may perform a seat location control function of controlling the seat to the target mode or to a restoring mode.

The manual switch may include at least one switch corresponding to a manual location control function of adjusting at least one of a slide location, a cushion height, a tilting angle, a reclining angle (or a backrest angle), or a leg rest angle of the seat, or any combination thereof, in accordance with a specific input received from the user. When a switch input (e.g., a touch input by the user) to the manual switch is detected, the seat control apparatus 100 may perform the seat location control function corresponding to the continuously detected switch input.

According to an embodiment, the driving part 120 may include at least one driving device that controls at least one of the slide location, the reclining angle, the cushion height, the tilting angle, or the leg rest angle of the seat, or any combination thereof.

For example, the driving part 120 may include at least one motor that controls the slide location of the seat to a front side and a rear side.

For example, the driving part 120 may include at least one of at least one motor that controls the reclining angle of the seat to a specific angle, or a recliner, or any combination thereof.

According to an embodiment, the memory 130 may store instructions and/or data. For example, the memory 130 may store one or more instructions that, when executed by the controller 140, cause the seat control apparatus 100 to perform various operations.

In an example, the memory 130 may be implemented with the controller 140 in one chip. The controller 140 may include at least one of a communication processor or a modem.

The memory 130 may store a previous operation mode of the seat. The controller 140, as an example, may control the seat, renew the operation mode corresponding to the state of the seat to an operation mode corresponding to a control result, and store the renewed operation mode in the memory 130.

According to an embodiment, the controller 140 may be operatively connected to at least one of the input part 110, the driving part 120, or the memory 130, or any combination thereof. For example, the controller 140 may control an operation of at least one of the input part 110, the driving part 120, or the memory 130, or any combination thereof.

The controller 140 may receive, through the input part 110, a switch input from the user regarding the target mode.

As an example, the controller 140 may receive, as a switch input, a user input (e.g., a touch input by the user) to at least one (e.g., an automatic switch corresponding to the target mode) of a plurality of input devices (e.g., switches) included in the input part 110.

The target mode may include at least one of a tip (or up) and slide mode, a walk-in slide mode, a backrest folding mode, a double folding mode, a stand-up mode, or a dive and go mode, or any combination thereof. The target mode, according to embodiments, is described in more detail below in connection with FIGS. 2A-2E.

In an example, in response to receiving the switch input, the controller 140 may identify a previous operation mode of the seat, and may determine one of the target mode and the restoring mode as a specific operation mode based on the identified previous operation mode of the seat. After determining the specific operation mode, the controller 140 may control the location of the seat by using the driving part 120 such that the location of the seat corresponds to the specific operation mode. The controller 140 may also renew the operation mode of the seat to the specific operation mode. The controller 140 may store the renewed operation mode in the memory 130.

As an example, when the identified previous operation mode is the target mode, the controller 140 may determine the target mode as the specific operation mode. The controller 140 may thus control the location of the seat such that the location of the seat corresponds to the target mode. The controller 14 may also renew the operation mode of the seat to the target mode. The controller 140 may store the renewed operation mode in the memory 130.

As another example, when the identified previous operation mode is the restoring mode, the controller 140 may determine the restoring mode as the specific operation mode. Accordingly, the controller 140 may control the location of the seat such that the location of the seat corresponds to the restoring mode. The controller 14 may also renew the operation mode of the seat to the restoring mode. The controller 140 may store the renewed operation mode in the memory 130.

In an example, the controller 140 may identify different reference operation modes according to which mode the seat is operated based when the switch input is received. The controller 140 may then perform a control of the location of the seat based on the identified reference operation mode.

As an example, when the seat is in a stopped state and the identified previous operation mode is a stop mode, the controller 140 may identify the reference operation mode corresponding to a case in which the switch input is received after the previous operation mode is set to the stop mode. The controller 140 may then control the location of the seat such that the location of the seat corresponds to the reference operation mode. The controller 140 may also renew the operation mode of the seat to the reference operation mode and. The controller 140 may store the renewed operation mode in the memory 130.

In an example, the controller 140 may identify whether the seat is operated in the target mode or the restoring mode when receiving the switch input. The controller 140 may then stop the operation of the seat when the seat is operated in the target mode or the restoring mode. The controller 140 may also renew the operation of the seat to the stop mode when the seat is stopped. The controller 140 may store the renewed operation mode in the memory 130.

As another example, the controller 140 may identify the operation state of the seat and a state of a host vehicle when receiving the switch input. The controller 140 may then perform a control of the location of the seat according to different operation modes based on whether the operation state of the seat and the state of the host vehicle satisfy specific conditions.

For example, the controller 140 may identify whether the seat is operated in the target mode or the restoring mode when the operation state of the seat satisfies a first condition and the state of the host vehicle satisfies a second condition. The controller 140 may then stop the operation of the seat when the seat is operated in the target mode or the restoring mode. The controller 140 may also renew the operation mode of the seat to the stop mode when the seat is stopped. The controller 140 may store the renewed operation mode in the memory 130.

In an example, when the operation state of the seat satisfies the first condition and the state of the host vehicle satisfies the second condition, the controller 140 may identify whether the seat is operated in the target mode or the restoring mode. When the seat is operated in a post-emptive operation mode of the target mode and the restoring mode or when the seat mode is not operated, the controller 140 may determine one of the target mode and the restoring mode as the specific operation mode based on the previous operation mode. The controller 140 may then control the location of the seat such that the location of the seat corresponds to the specific operation mode. The controller 140 may also renew the operation mode of the seat to the specific operation mode. The controller 140 may store the renewed operation mode in the memory 130.

As an example, when the seat is operated in the pre-emptive operation mode of the target mode and the restoring mode, the controller 140 may determine that the operation state of the seat does not satisfy the first condition. The pre-emptive operation mode may be a setting value that may be changed through setting by a producer and/or setting by the user. In this case, the controller 140 may continuously control the location of the seat in the pre-emptive operation mode while neglecting the switch input.

As another example, when the door corresponding to the seat is closed, the safety belt of the seat is in a fastened state, a passenger is seated on the seat, the gearshift of the host vehicle is not set to stage “P”, or the travel speed of the host vehicle is more than a specific speed, the controller 140 may determine that the state of the host vehicle does not satisfy the second condition. A parameter regarding the second condition may be changed through setting by the producer and/or setting by the user. In this case, the controller 140 may stop the control of the location of the seat while neglecting the switch input.

Hereinafter, embodiments of various operation states (or operation modes) of a seat that may be set based on a control of the location of a seat control apparatus (e.g., the seat control apparatus 100 of FIG. 1) are described with reference to FIGS. 2A-2E.

FIG. 2A is a conceptual view illustrating an operation state of the seat through a control by the seat control apparatus, according to an embodiment of the present disclosure.

According to an embodiment, the seat control apparatus (e.g., the seat control apparatus 100 of FIG. 1) may control locations (or angles) of a backrest 251 and a cushion 261 of the seat to a general mode or a tip (or up) and slide mode.

Referring to reference numeral 211, according to an embodiment, the seat control apparatus may control the locations of the backrest 251 and the cushion 261 of the seat based on the general mode. The general mode may be defined as a location state of the seat in a general situation in which the user may be conveniently seated while the host vehicle travels.

According to an embodiment, when receiving a switch input (e.g., a pressure input by the user to an automatic switch corresponding to the tip and slide mode) corresponding to a request for an operation of the tip and slide mode while the location state of the seat is maintained based on the general mode, the seat control apparatus may control the seat to the location state as illustrated in a view 221. For example, the seat control apparatus may control the operation mode of the seat to the tip and slide mode by moving the backrest 251 of the seat to a front side by adjusting an angle of the backrest 251 and moving the cushion 261 to a front side. Through the control of the location of the seat, the user may move to the rear seat of the seat illustrated in FIG. 2A conveniently and promptly.

FIG. 2B is a conceptual view illustrating an operation state of the seat through a control by the seat control apparatus, according to an embodiment of the present disclosure.

According to an embodiment, the seat control apparatus (e.g., the seat control apparatus 100 of FIG. 1) may control the locations (or angles) of a backrest 252 and a cushion 262 of the seat to the general mode or a walk-in slide mode.

Referring to a view 212, according to an embodiment, the seat control apparatus may control the locations of the backrest 252 and the cushion 262 of the seat based on the general mode. The general mode may be defined as a location state of the seat in a general situation in which the user may be conveniently seated while the host vehicle travels.

According to an embodiment, when receiving a switch input (e.g., a pressure input by the user to the automatic switch corresponding to the walk-in slide mode) corresponding to a request for an operation to the walk-in slide mode while the location state of the seat is maintained based on the general mode, the seat control apparatus may control the seat to a location state as illustrated in a view 222. For example, the seat control apparatus may control the operation mode of the seat to the walk-in mode by moving the backrest 251 of the seat to a front side by adjusting an angle of the backrest 252 of the seat and moving the cushion 262 to a front side. Through the control of the location of the seat, the user may move to the rear seat of the seat illustrated in FIG. 2B conveniently and promptly.

FIG. 2C is a conceptual view illustrating an operation state of the seat through a control by the seat control apparatus, according to an embodiment of the present disclosure.

According to an embodiment, the seat control apparatus (e.g., the seat control apparatus 100 of FIG. 1) may control the locations (or angles) of a backrest 253 and a cushion 263 of the seat to the general mode or a double folding mode.

Referring to a view 213, according to an embodiment, the seat control apparatus may control the locations of the backrest 253 and the cushion 263 of the seat based on the general mode. The general mode may be defined as the location state of the seat in a general situation in which the user may be conveniently seated while the host vehicle travels.

According to an embodiment, when receiving a switch input (e.g., a pressure input by the user to the automatic switch corresponding to the double folding mode) corresponding to a request for an operation to the double folding mode while the location state of the seat is maintained based on the general mode, the seat control apparatus may control the seat to a location state as illustrated in a view 223. For example, the seat control apparatus may move (or fold) the backrest 253 to a front side by adjusting the angle of the backrest 253 of the seat. Thereafter, the seat control apparatus may control the seat to the location state according to as illustrated in a view 233.

Referring to the view 233, according to an embodiment, when the folding of the backrest 253 is ended through adjusting of the angle of the backrest 253, the seat control apparatus may control the operation mode of the seat to the double folding mode by raising a rear end of the cushion 263 to an upper side. Through the control of the location of the seat, the user may move to the rear seat of the seat illustrated in FIG. 2C conveniently and promptly.

FIG. 2D is a conceptual view illustrating an operation state of the seat through a control by the seat control apparatus, according to an embodiment of the present disclosure.

According to an embodiment, the seat control apparatus (e.g., the seat control apparatus 100 of FIG. 1) may control the locations (or angles) of a backrest 254 and a cushion 264 of the seat to the general mode or a dive and go mode.

Referring to a view 214, according to an embodiment, the seat control apparatus may control the locations of the backrest 254 and the cushion 264 of the seat based on the general mode. The general mode may be defined as the location state of the seat in a general situation in which the user may be conveniently seated while the host vehicle travels.

According to an embodiment, when receiving a switch input (e.g., a pressure input by the user to the automatic switch corresponding to the dive and go mode) corresponding to a request for an operation to the walk-in slide mode while the location state of the seat is maintained based on the general mode, the seat control apparatus may control the seat to a location state as illustrated in a view 224. For example, the seat control apparatus may control the operation mode of the seat to the dive and go mode by moving (or folding) the backrest 254 to a front side by adjusting the angle of the backrest 254 of the seat and by moving the cushion 264 to a lower side. Through the control of the location of the seat, the user may move to the rear seat of the seat illustrated in FIG. 2D conveniently and promptly.

FIG. 2E is a conceptual view illustrating an operation state of the seat through a control by the seat control, apparatus according to an embodiment of the present disclosure.

According to an embodiment, the seat control apparatus (e.g., the seat control apparatus 100 of FIG. 1) may control the locations (or angles) of a backrest 255 and a cushion 265 of the seat to the general mode or a stand-up mode.

Referring to a view 215, according to an embodiment, the seat control apparatus may control the locations of the backrest 254 and the cushion 264 of the seat based on the general mode. The general mode may be defined as the location state of the seat in a general situation, in which the user may be conveniently seated while the host vehicle travels.

According to an embodiment, when receiving a switch input (e.g., the input part 110 corresponding to the stand-up mode) (or the automatic switch) corresponding to a request for an operation to the stand-up mode while the location state of the seat is maintained based on the general mode, the seat control apparatus may control the seat to a location state as illustrated in a view 225. For example, the seat control apparatus may implement the stand-up operation mode of making the seat upright by moving the backrest 255 to a front side by adjusting the angle of the backrest 255 of the seat and by raising a rear end of the cushion 265 to an upper side. Through the control of the location of the seat, the user may move to the rear seat of the seat illustrated in FIG. 2E conveniently and promptly.

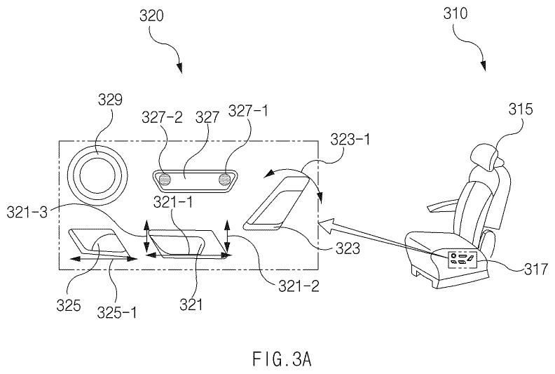

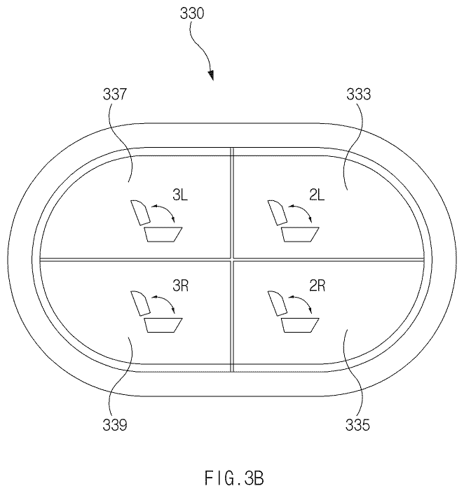

FIGS. 3A and 3B are views illustrating example implementations of an input part (e.g., the input part 110 of FIG. 1) included in a seat control apparatus (e.g., the seat control apparatus 100 of FIG. 1).

FIG. 3A is a conceptual view illustrating the input part of the seat control apparatus, according to an embodiment of the present disclosure.

Referring to a view 310, according to an embodiment, the seat control apparatus may include the input part that is disposed in one area 317 of a seat 315. The one area 317 of the seat 315 may be a part of a side area of the seat. However, this is illustrative. Embodiments of the present disclosure are not limited thereto.

Referring to a view 320, according to an embodiment, the input part may include a plurality of switches corresponding to a plurality of types.

For example, the input part may include a first switch 321 that controls at least one of a slide location, a location of a cushion, or a tilting angle of the cushion of the seat 315, or any combination thereof. As an example, the first switch 321 may be a manual switch. The seat control apparatus may perform a control of the location of the seat according to an input type (or an input direction) of a user input to the first switch 321. In an example, because the first switch 321 is a manual switch, the control of the location corresponding to the user input may be continuously performed in accordance with the user input to the first switch 321. Further, because the first switch 321 is a manual switch, when the user input is stopped, the control of the location may be accordingly stopped.

As an example, when receiving a user input in a first direction 321-1 to the first switch 321, the seat control apparatus may adjust the slide location of the seat 315 in the first direction 321-1 (e.g., a forward direction or a rearward direction).

As another example, when receiving a user input in a second direction 321-2 to the first switch 321, the seat control apparatus may adjust the location of the cushion of the seat 315 in the second direction 321-2 (e.g., an upward direction or a downward direction).

As yet another example, when receiving a user input in a third direction 321-3 to the first switch 321, the seat control apparatus may adjust the tilting angle of the cushion in the third direction 321-3 (e.g., an upward direction or a downward direction). The tilting angle of the cushion may include an angle of a front end of the cushion.

In an example, the input part may include a second switch 323 that controls the reclining angle (or an angle of the backrest) of the seat 315. As an example, the second switch 323 may be a manual switch. The seat control apparatus may perform a control of the location of the seat according to an input type (or an input direction) of the user input to the second switch 323. In an example, because the second switch 323 is a manual switch, the control of the location corresponding to the user input may be continuously performed in correspondence to the user input to the second switch 323. Further, because the second switch 323 is a manual switch, when the user input is stopped, the control of the location may be accordingly stopped.

As an example, when receiving a user input in a fourth direction 323-1 to the second switch 323, the seat control apparatus may adjust the reclining angle of the seat 315 in the fourth direction 323-1. For example, the seat control apparatus may fold the reclining angle of the seat 315 toward a front side or unfold the reclining angle of the seat 315 toward a rear side in a direction corresponding to the user input.

In an example, the input part may include a third switch 325 that controls the angle of the leg rest of the seat 315. As an example, the third switch 325 may be a manual switch. The seat control apparatus may perform a control of the location of the seat according to an input type (or an input direction) of the user input to the third switch 325. In an example, because the third switch 325 is a manual switch, the control of the location corresponding to the user input may be continuously performed in accordance with the user input to the third switch 325. Further, because the third switch 325 is a manual switch, when the user input is stopped, the control of the location may be accordingly stopped.

As an example, when receiving a user input in a fifth direction 325-1 to the third switch 325, the seat control apparatus may adjust the reclining angle of the seat 315 in a direction corresponding to the fifth direction 325-1. For example, when receiving a user input for pushing the third switch 325 to a left side, the seat control apparatus may adjust the angle of the leg rest such that an end of the leg rest of the seat 315 is moved toward a ceiling of the host vehicle. As another example, when receiving a user input for pushing the third switch 325 to a right side, the seat control apparatus may adjust the angle of the leg rest such that the end of the leg rest of the seat 315 is moved toward a bottom of the host vehicle.

In an example, the input part may include a fourth switch 327 that controls the operation mode of the seat 315 to a relaxation mode. As an example, the fourth switch 327 may be an automatic switch. When receiving a user input (e.g., a pressure input to one area of the fourth switch 327) to the fourth switch 327, the seat control apparatus may identify a corresponding function corresponding to the switch by which the user input is received. The seat control apparatus may then perform a control of the location of the seat to an operation mode corresponding to the corresponding function. In an example, because the fourth switch 327 is an automatic switch, a control of the location corresponding to the corresponding user input may be continuously performed in accordance with the user input to the fourth switch 327. Further, because the fourth switch 327 is an automatic switch, the control of the location of the seat may be continuously performed in the operation mode corresponding the user input even when the user input is stopped.

As an example, when receiving a user input to a first area 327-1 of the fourth switch 327, the seat control apparatus may automatically control the seat 315 to the relaxation mode. The seat control apparatus may thus automatically control the seat 315 such that the seat 315 corresponds to the relaxation mode with only a one touch input to the first area 327-1.

As another example, when receiving a user input to a second area 327-2 of the fourth switch 327, the seat control apparatus may automatically control the seat 315 to an original state (e.g., the general mode according to reference numeral 211 of FIG. 2A) in the relaxation mode. The seat control apparatus may thus automatically control the seat 315 such that the seat 315 corresponds to the general mode with only a one touch input to the second area 327-2.

In an example, the input part may include a fifth switch 329 that controls the operation mode of the seat to various operation modes (e.g., at least one of the tip and slide mode, the walk-in slide mode, the backrest folding mode, the double folding mode, the stand-up mode, or the dive and go mode, or any combination thereof). As an example, the fifth switch 329 may be an automatic switch. When receiving a user input to the fifth switch 329 (e.g., a pressure input to one area of the fifth switch 329), the seat control apparatus may identify a corresponding function corresponding to the switch by which the corresponding user input is received. The seat control apparatus may then perform a control of the location of the seat to an operation mode (or the target mode) corresponding to the corresponding function. In an example, because the fifth switch 329 is an automatic switch, a control of the location corresponding to the corresponding user input may be continuously performed in correspondence to the user input to the fifth switch 329. Further, because the fifth switch 329 is an automatic switch, the control of the location of the seat may be continuously performed in the operation mode corresponding the user input even when the user input is stopped.

As an example, when receiving a user input to at least a portion of the fifth switch 329, the seat control apparatus may automatically control the seat 315 to a specific target state based on a corresponding function to the fifth switch 329. The seat control apparatus may thus automatically control the seat 315 to a specific target state with only a one touch input to the fifth switch 329.

As another example, when receiving a user input to at least a portion of the fifth switch 329 in a situation in which the seat 315 is operated in a specific target state, the seat control apparatus may automatically control the seat to the general mode in the specific target state. The seat control apparatus may thus automatically restore the seat 315 from the specific target state to the general mode even only with a one touch input to the fifth switch 329.

FIG. 3B is a conceptual view illustrating the input part of the seat control apparatus, according to an embodiment of the present disclosure.

Referring to a view 330, according to an embodiment, the seat control apparatus may include an input part that is disposed in areas (e.g., one area of a luggage trim of a seat of row 3), other than the one area 317 of the seat 315 illustrated in FIG. 2A.

In an example, the input part may include at least one switch 333, 335, 337, and/or 339 that allows the seat control apparatus to adjust angles of the backrests of, among the plurality of seats, the left and right seats of row 2 and the left and right seats of row 3 in the host vehicle.

As an example, the at least one switch 333, 335, 337, and 339 may be an automatic switch.

When receiving a user input to at least one switch 333, 335, 337, and 339, the seat control apparatus may identify a corresponding function corresponding to the switch by which the corresponding user input is received. The seat control apparatus may then perform a control of the location of the seat in an operation mode corresponding to the corresponding function.

In an example, because the at least one switch 333, 335, 337, and 339 is an automatic switch, a control of the location corresponding to the corresponding user input may be continuously performed in accordance with the user input to the at least one switch 333, 335, 337, and 339. Further, because the at least one switch 333, 335, 337, and 339 is an automatic switch, the control of the location of the seat may be continuously performed in the operation mode corresponding the user input even when the user input is stopped.

As an example, the first folding switch 333 may be an input device that folds a left seat of row 2 by allowing the seat control apparatus to adjust an angle of the backrest of the seat to a front side based on the received user input.

As an example, the second folding switch 335 may be an input device that folds a right seat of row 2 by allowing the seat control apparatus to adjust an angle of the backrest of the seat to a front side based on the received user input.

As an example, the third folding switch 337 may be an input device that folds a left seat of row 3 by allowing the seat control apparatus to adjust an angle of the backrest of the seat to a front side based on the received user input.

As an example, the fourth folding switch 339 may be an input device that folds a right seat of row 3 by allowing the seat control apparatus to adjust an angle of the backrest of the seat to a front side based on the received user input.

As an example, after adjusting the angle of the backrest of a specific seat based on the user input to the at least one switch 333, 335, 337, and 339 and when receiving a user input to the at least one switch 333, 335, 337, and 339 corresponding to the specific seat in turn, the seat control apparatus may automatically restore the angle of the backrest of the specific seat.

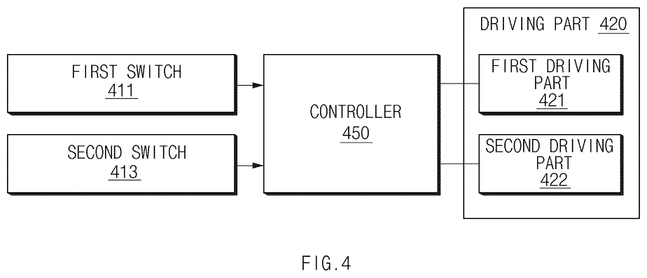

FIG. 4 is a block diagram illustrating components of a seat control apparatus, according to an embodiment of the present disclosure.

According to an embodiment, the seat control apparatus (e.g., the seat control apparatus 100 of FIG. 1) may include at least one of a first switch 411, a second switch 413, a driving part 420, or a controller 440 (e.g., the controller 140 of FIG. 1), or any combination thereof. In an example, the driving part 420 may include a first driving device 421 and a second driving device 422.

The seat control apparatus may receive a switch input for controlling the location of the seat from the first switch 411 and/or the second switch 413.

In an example, the first switch 411 may include at least one automatic switch.

In an example, the second switch 413 may include at least one manual switch.

The first switch 411 and the second switch 413 may be configured as described above in connection with FIGS. 3A and 3B.

In an example, when receiving a switch input, the seat control apparatus may identify a previous operation mode of the seat. The seat control apparatus may then determine one of the target mode and the restoring mode as the specific operation mode based on the identified previous operation mode.

The seat control apparatus may control the operation mode of the seat based on the determined specific operation mode by using at least some of the components of the driving part 420.

For example, the seat control apparatus may control the location of the seat such that the seat corresponds to a specific target state by using at least one of the first driving device 421, or the second driving device 422, or any combination thereof.

The driving part 420 may deliver information on the operation states of the driving devices to the controller 440.

As an example, the first driving device 421 may include a slide driving part that controls the slide location of the seat.

As an example, the second driving device 422 may include a backrest driving part that controls the reclining angle of the seat.

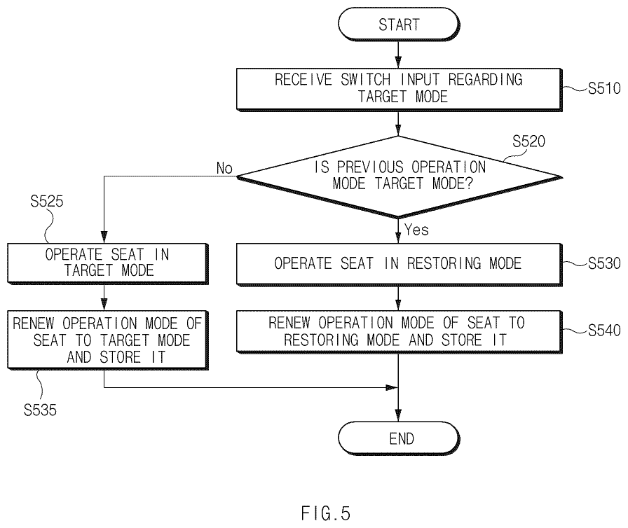

FIG. 5 is a flowchart of a seat control method, according to an embodiment of the present disclosure.

According to an embodiment, the seat control apparatus (e.g., the seat control apparatus 100 of FIG. 1) may perform operations illustrated in FIG. 5. For example, some of the components (e.g., the input part 110, the driving part 120, the memory 130, and the controller 140 of FIG. 1) included in the seat control apparatus may be configured to perform the operations illustrated in FIG. 5.

In embodiments, operations S510-S540 illustrated in FIG. may be sequentially performed. In other embodiments, the operations S510-S540 are not necessarily sequentially performed. For example, the sequence of the operations may be changed and/or at least two operations may be performed in parallel. It is noted that contents corresponding to the contents described above or repeated contents may have been briefly described in connection with FIG. 5 below or may have been omitted from the description below in connection with FIG. 5.

In an operation S510, the seat control apparatus may receive a switch input regarding a target mode.

For example, the seat control apparatus may receive a pressure input by the user to, among a plurality of switches included in an input part, an automatic switch regarding the target mode.

In an operation S520, the seat control apparatus may identify whether the previous operation mode is the target mode.

For example, the seat control apparatus may identify whether the previous operation mode of the seat is the target mode with reference to a history regarding the operation state of the seat The history may, for example, be stored in the memory.

When the previous operation mode is the target mode (e.g., Yes in the operation S520), the seat control apparatus may perform operation S530.

When the previous operation mode is not the target mode (e.g., No in the operation S520), the seat control apparatus may perform operation S525.

In the operation S530, the seat control apparatus may operate the seat in the restoring mode.

For example, when receiving a switch input in a situation, in which the previous operation mode of the seat is the target mode, the seat control apparatus may control the seat to the restoring mode corresponding to an opposite mode to the target mode.

In an operation S540, the seat control apparatus may renew the operation mode of the seat to the restoring mode and may store the renewed operation mode.

For example, when the operation of controlling the seat to the restoring mode is completed, the seat control apparatus may renew the operation mode of the seat to the restoring mode and store the renewed operation mode in the memory. Thereafter, the seat control apparatus may identify the previous operation mode as the restoring mode.

In the operation S525, the seat control apparatus may operate the seat in the target mode.

For example, when receiving a switch input in a situation in which the previous operation mode of the seat is not the target mode (e.g., a situation in which the previous operation mode is the restoring mode), the seat control apparatus may control the seat to the target mode corresponding to the opposite mode to the restoring mode.

In an operation S535, the seat control apparatus may renew the operation mode of the seat to the target mode and may store the renewed operation mode.

For example, when the operation of controlling the seat to the target mode is ended, the seat control apparatus may renew the operation mode of the seat to the target mode and may store the renewed operation mode. Thereafter, the seat control apparatus may identify the previous operation mode as the target mode.

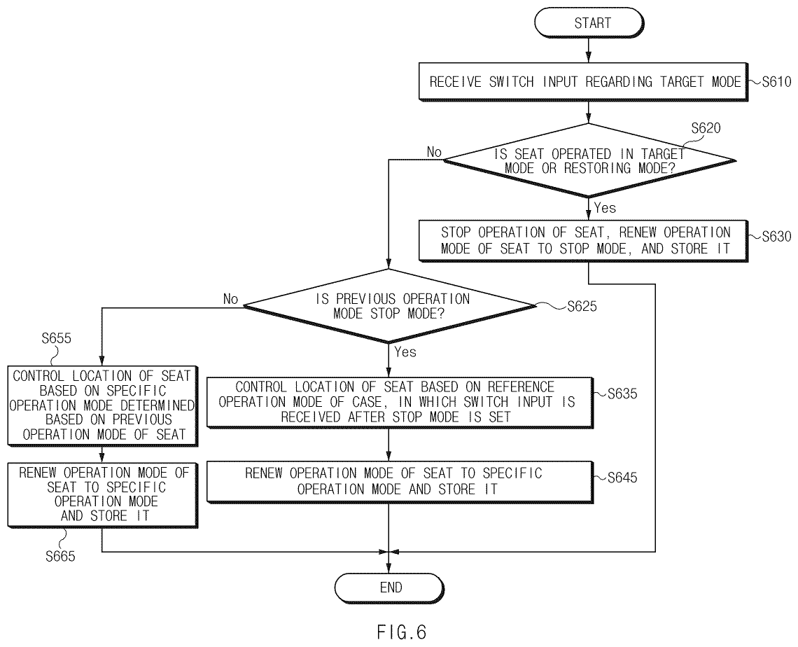

FIG. 6 is a flowchart of a seat control method, according to an embodiment of the present disclosure.

According to an embodiment, the seat control apparatus (e.g., the seat control apparatus 100 of FIG. 1) may perform operations illustrated in FIG. 6. For example, at least some of the components (e.g., the input part 110, the driving part 120, the memory 130, and the controller 140) included in the seat control apparatus may be configured to perform the operations of FIG. 6.

In embodiments, operations S610-S665 illustrated in FIG. 6 may be sequentially performed. In other embodiments, the operations S610-S665 are not necessarily sequentially performed. For example, the sequence of the operations may be changed and/or at least two operations may be performed in parallel. It is noted that contents corresponding to the contents described above or repeated contents may have been briefly described in connection with FIG. 6 below or may have been omitted from the description below in connection with FIG. 6.

In an operation S610, the seat control apparatus may receive a switch input regarding a target mode.

For example, the seat control apparatus may receive a pressure input by the user to, among a plurality of switches included in the input part, an automatic switch regarding the target mode.

In an operation S620, the seat control apparatus may identify whether the seat is operated in the target mode or the restoring mode.

For example, the seat control apparatus may identify whether the seat is currently operated in the target mode or the restoring mode at a time point at which the switch input is received.

When the seat is operated in the target mode or the restoring mode (e.g., Yes in the operation S620), the seat control apparatus may perform operation S630.

When the seat is not operated in the target mode or the restoring mode (e.g., No in the operation S620), the seat control apparatus may perform operation S625.

In the operation S630, the seat control apparatus may stop the operation of the seat, may renew the operation mode of the seat to the stop mode, and may store the renewed operation mode.

In an example, the seat control apparatus may stop the operation of the seat, and then may renew the operation mode of the seat to a stop mode. The seat control apparatus may then store the renewed operation mode in the memory. Thereafter, the seat control apparatus may identify the previous operation mode as the stop mode.

In the operation S625, the seat control apparatus may identify whether the previous operation mode of the seat is the stop mode.

For example, the seat control apparatus may identify whether the previous operation mode of the seat is the stop mode with reference to a history regarding the operation state of the seat. The history may, for example, be stored in the memory.

When the previous operation mode is the stop mode (e.g., Yes in the operation S625), the seat control apparatus may perform operation S635.

When the previous operation mode is not the stop mode (e.g., No in the operation S625), the seat control apparatus may perform operation S655.

In the operation S635, the seat control apparatus may perform a control of the location of the seat based on a reference operation mode.

For example, the seat control apparatus may identify the reference operation mode stored in the memory. As an example, the reference operation mode may be an operation mode corresponding to a case in which a switch input is received after the previous operation mode is set to the stop mode.

In an operation S645, the seat control apparatus may renew the operation mode of the seat to the reference operation mode and may store the renewed operation mode.

For example, the seat control apparatus may end the control of the seat to the reference operation mode, and then may renew the operation mode of the seat to the reference operation mode and may store the renewed operation mode in the memory. Thereafter, the seat control apparatus may identify the previous operation mode as the reference operation mode. The reference operation mode, for example, may include the target mode or the restoring mode.

In the operation S655, the seat control apparatus may perform a control of the location of the seat based on the specific operation mode determined based on the previous operation mode of the seat.

For example, when the previous operation mode is not the stop mode (or when the previous operation mode is the target mode or the restoring mode), the seat control apparatus may determine the specific operation mode based on the previous operation mode, and may perform a control of the location of the seat based on the determined specific operation mode.

In an operation S665, the seat control apparatus may renew the operation mode of the seat to the specific operation mode and may store the renewed operation mode.

For example, the seat control apparatus may end the control of the seat to the specific operation mode. The seat control apparatus may then renew the operation mode of the seat to the specific operation mode and may store the renewed operation mode in the memory. Thereafter, the seat control apparatus may identify the previous operation mode as the reference operation mode. The reference operation mode, for example, may include the target mode or the restoring mode.

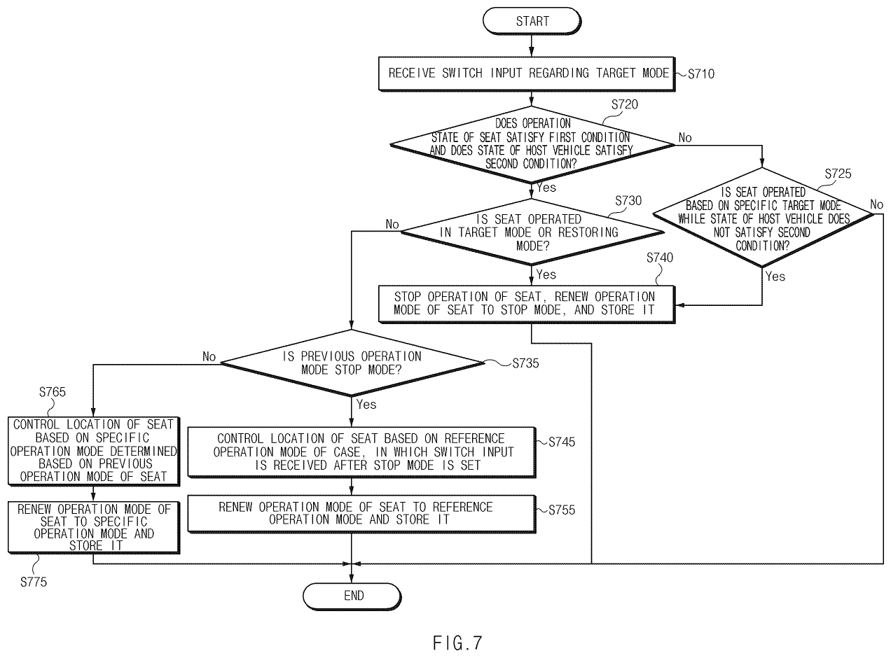

FIG. 7 is a flowchart of a seat control method, according to an embodiment of the present disclosure.

According to an embodiment, the seat control apparatus (e.g., the seat control apparatus 100 of FIG. 1) may perform operations disclosed in FIG. 7. For example, some of the components (e.g., the input part 110, the driving part 120, the memory 130, and the controller 140 of FIG. 1) included in the seat control apparatus may be configured to perform the operations of FIG. 7.

In the embodiments, operations S710-S775 illustrated in FIG. 7 may be sequentially performed. In other embodiments, the operations S710-S775 are not necessarily sequentially performed. For example, the sequence of the operations may be changed and/or at least two operations may be performed in parallel. It is noted that contents corresponding to the contents described above or repeated contents may have been briefly described below in connection with FIG. 7 or may have been omitted from the description below in connection with FIG. 7.

In an operation S710, the seat control apparatus may receive a switch input regarding a target mode and may identify a state of a host vehicle.

For example, the seat control apparatus may receive a pressure input by the user to, among a plurality of switches included in an input part, an automatic switch on the target mode.

In an example, when receiving a switch input, the seat control apparatus may identify an operation state of the seat and/or the state of the host vehicle. The state of the host vehicle, for example, may include at least one of a travel speed, whether a door corresponding to the seat is opened or closed, a fastening state of a safety belt, a seating state of a passenger, or a state of a gearshift, or any combination thereof.

In an operation S720, the seat control apparatus may identify whether the operation state of the seat satisfies a first condition and the state of the host vehicle satisfies a second condition.

For example, when the seat is operated in a pre-emptive operation mode of the target mode and the restoring mode, the seat control apparatus may determine that the operation state of the seat does not satisfy the first condition.

For example, when the door corresponding to the seat is closed, the safety belt of the seat is in a fastened state, a passenger is seated on the seat, the gearshift of the host vehicle is not set to stage “P”, or the travel speed of the host vehicle is more than a specific speed, the seat control apparatus may determine that the state of the host vehicle does not satisfy the second condition.

When the operation state of the seat satisfies the first condition and the state of the host vehicle satisfies the second condition (e.g., Yes in the operation S720), the seat control apparatus may perform operation S730.

When the operation state of the seat does not satisfy the first condition or the state of the host vehicle does not satisfy the second condition (e.g., No in the operation 720), the seat control apparatus may perform operation S725.

In the operation S720, the seat control apparatus may identify whether the state of the host vehicle does not satisfy the second condition and the seat is operated based on the specific target mode.

For example, the seat control apparatus may identify whether the state of the host vehicle does not satisfy the second condition and the seat is operated based on the specific target mode as well. The specific target mode, for example, may include at least one of the target mode, the restoring mode, or the post-emptive operation mode of the target mode and the restoring mode, or any combination thereof.

When the state of the host vehicle does not satisfy the second condition and the seat is operated based on the specific target mode (e.g., Yes in the operation S725), the seat control apparatus may perform operation S740.

When the state of the host vehicle satisfies the second condition or the seat is not operated based on the specific target mode (or the seat is operated based on the pre-emptive operation mode of the target mode and the restoring mode) (e.g., No in the operation S725), the seat control apparatus may end the operation. Accordingly, in this case, the seat control apparatus may end the operation and may stop the control of the location of the seat.

In an operation S730, the seat control apparatus may identify whether the seat is operated in the target mode or restoring mode.

For example, the seat control apparatus may identify whether the seat is currently operated in the target mode or the restoring mode at a time point, at which the switch input is received.

When the seat is operated in the target mode or the restoring mode (e.g., Yes in the operation S730), the seat control apparatus may perform operation S740.

When the seat is not operated in the target mode or the restoring mode (e.g., No in the operation S730), the seat control apparatus may perform operation S735.

In the operation S740, the seat control apparatus may stop the operation of the seat and may renew the operation mode of the seat to a stop mode and may store the renewed operation mode.

For example, the seat control apparatus may stop the operation of the seat, and then may renew the operation mode of the seat to a stop mode and may store the renewed operation mode in the memory. Thereafter, the seat control apparatus may identify the previous operation mode as the stop mode.

In the operation S735, the seat control apparatus may identify whether the previous operation mode of the seat is the stop mode.

For example, the seat control apparatus may identify whether the previous operation mode of the seat is the stop mode with reference to a history regarding the operation state of the seat, which is stored in the memory.

When the previous operation mode is the stop mode (e.g., Yes in the operation S735), the seat control apparatus may perform operation S745.

When the previous operation mode is not the stop mode (e.g., No in the operation S735), the seat control apparatus may perform operation S765.

In the operation S745, the seat control apparatus may perform a control of the location of the seat based on the reference operation mode.

For example, the seat control apparatus may identify the reference operation mode stored in the memory. As an example, the reference operation mode is an operation mode corresponding to a case, in which a switch input is received after the previous operation mode is set to the stop mode.

In the operation S755, the seat control apparatus may renew the operation mode of the seat to the reference operation mode and may store the renewed operation mode.

For example, the seat control apparatus may end the control of the seat to the reference operation mode. The seat control apparatus may then renew the operation mode of the seat to the reference operation mode and store the renewed operation mode in the memory. Thereafter, the seat control apparatus may identify the previous operation mode as the reference operation mode. The reference operation mode, for example, may include the target mode or the restoring mode.

In an operation S765, the seat control apparatus may perform a control for the location of the seat based on the specific operation mode determined based on the previous operation mode of the seat.

For example, when the previous operation mode is not the stop mode (or when the previous operation mode is the target mode or the restoring mode), the seat control apparatus may determine the specific operation mode based on the previous operation mode and may perform a control of the location of the seat based on the determined specific operation mode.

In an operation S755, the seat control apparatus may renew the operation mode of the seat to the specific operation mode and may store the renewed operation mode.

For example, the seat control apparatus may end the control of the seat to the specific operation mode, and then may renew the operation mode of the seat to the specific operation mode and may store the renewed operation mode in the memory. Thereafter, the seat control apparatus may identify the previous operation mode as the specific operation mode. The specific operation mode, for example, may include the target mode or the restoring mode.

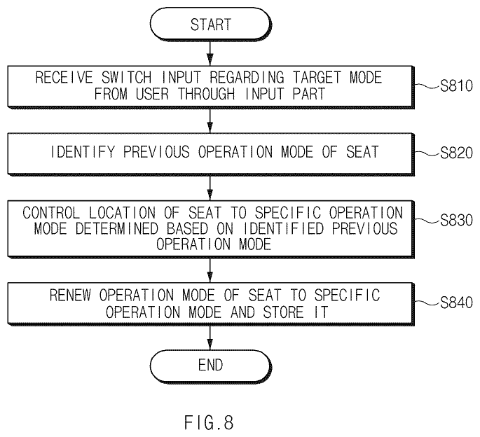

FIG. 8 is a flowchart of a seat control method, according to an embodiment of the present disclosure.

According to an embodiment, the seat control apparatus (e.g., the seat control apparatus 100 of FIG. 1) may perform operations disclosed in FIG. 8. For example, at least some of the components (e.g., the input part 110, the driving part 120, the memory 130, and the controller 140) included in the seat control apparatus may be configured to perform the operations of FIG. 8.

In the embodiments, operations S810-S840 illustrated in FIG. 8 may be sequentially performed. In other embodiments, the operations S810-S840 are not necessarily sequentially performed. For example, the sequence of the operations may be changed and/or at least two operations may be performed in parallel. It is noted that contents corresponding to the contents described above or repeated contents may have been briefly described below in connection with FIG. 8 or may have been omitted from the description below in connection with FIG. 8.

In an operation S810, the seat control apparatus may receive a switch input regarding a target mode from the user through the input part.

For example, the seat control apparatus may receive a pressure input by the user to, among a plurality of switches included in the input part, an automatic switch regarding the target mode.

In an operation S820, the seat control apparatus may identify the previous operation mode.

For example, the seat control apparatus may identify the previous operation mode with reference to a history regarding the operation state of the seat. The history may, for example, be stored in the memory.

In an operation S830, the seat control apparatus may control the location of the seat to the specific operation mode determined based on the identified previous operation mode.

In embodiments, determining the specific operation mode by the seat control apparatus may be performed as described above in connection with FIG. 1 and FIG. 5-7, for example.

In an operation S840, the seat control apparatus may renew the operation mode of the seat to the specific operation mode and may store the renewed operation mode.

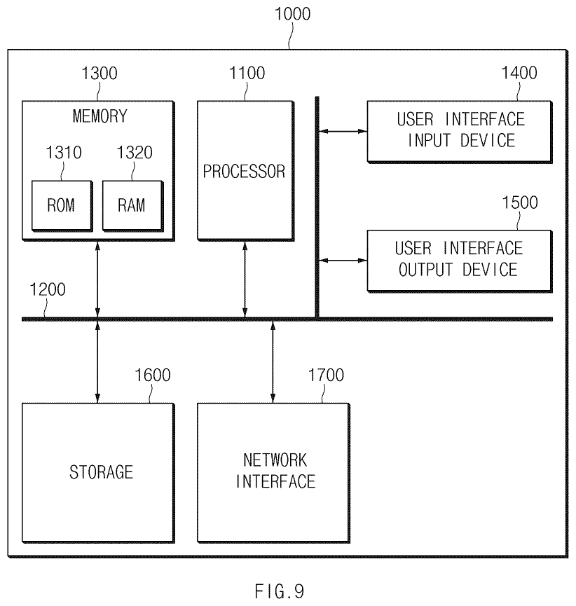

FIG. 9 illustrating a computing system that may implement a seat control method, according to an embodiment of the present disclosure.

Referring to FIG. 9, the seat control method according to an embodiment of the present disclosure may be implemented through a computing system 1000. The computing system 1000 may include at least one processor 1100, a memory 1300, a user interface input device 1400, a user interface output device 1500, storage 1600, and a network interface 1700, which are connected through a bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the steps or operations of the method or algorithm according to the embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, a solid state drive (SSD), a detachable disk, or a CD-ROM.

The storage medium is coupled to the processor 1100. In another example, the storage medium may be integrated with the processor 1100. The processor 1100 may read information from the storage medium and may write information in the storage medium. The processor and the storage medium may reside in an application specific integrated circuit (ASIC). The ASIC may reside in a user terminal. In another method, the processor and the storage medium may reside in the user terminal as an individual component.

Effects of the seat control apparatus and the seat control method according to the present disclosure are described as follows.

According to at least one of the embodiments of the present disclosure, the seat control apparatus may perform a control of a location of a seat that better agrees with an intention of a user. The seat control apparatus may selectively identify a specific operation mode corresponding to a switch input based on a previous operation mode of the seat when receiving the switch input through the input part.

Furthermore, according to at least one of the embodiments of the present disclosure, a specific operation mode may be identified based on at least one of a type of a switch corresponding to a switch input, a corresponding function, a current operation state of the seat, or a previous operation mode of the seat, or any combination thereof. The location of the seat may then be controlled to correspond to the specific operation mode by using a driving part.

In addition, according to at least one of the embodiments of the present disclosure, an operation mode for controlling the location of the seat may be identified further based on a state of the host vehicle (e.g., at least one of a travel speed, an opening/closing state of a door corresponding to the seat, a fastening state of a safety belt, a seating state of a passenger, or a state of a gearshift, or any combination thereof), as well as an operation state of the seat.

In addition, various effects directly or indirectly recognized through the specification may be provided.

The above description is illustrative of the technical spirits of the present disclosure. It should be understood by those of ordinary skill in the art to which the present disclosure pertains that various variations and modifications may be made without departing from the spirit and scope of the present disclosure.

Therefore, the embodiments disclosed in the present disclosure are not intended to limit the technical spirit of the present disclosure. Rather, the embodiments disclosed in the present disclosure are intended to describe the technical concepts of the present disclosure. The scope and the technical spirit of the present disclosure are not limited by the embodiments. The scope of the present disclosure should be determined by the following claims. All changes within the equivalent scope should be construed as being included in the scope of the present disclosure.

What is claimed is:

1. A seat control apparatus comprising:
an input part disposed in one area of a seat;
a driving part configured to control at least one of a reclining angle, a slide location, or a cushion angle of the seat, or any combination thereof;
a memory configured to store one or more instructions; and
a controller operatively connected to the input part, the driving part, and the memory,
wherein the instructions, when executed by the controller, cause the seat control apparatus to
receive a switch input regarding a target mode, wherein the switch input is provided by a user through the input part,
identify a previous operation mode of the seat,
determine, based on the previous operation mode, one of the target mode and a restoring mode as a specific operation mode,
control a location of the seat by using the driving part such that the location of the seat corresponds to the specific operation mode,
renew an operation mode of the seat to the specific operation mode, and
store the renewed operation mode in the memory.

2. The seat control apparatus of claim 1, wherein the target mode includes at least one of a tip and slide mode, a walk-in slide mode, a backrest folding mode, a double folding mode, a stand-up mode, or a dive and go move, or any combination thereof.

3. The seat control apparatus of claim 1, wherein the instructions, when executed by the controller, cause the seat control apparatus to:
determine the target mode as the specific operation mode when the identified previous operation mode is the restoring mode;
control the location of the seat such that the location of the seat corresponds to the target mode;
renew the operation mode of the seat to the target mode; and
store the renewed operation mode in the memory.

4. The seat control apparatus of claim 1, wherein the instructions, when executed by the controller, cause the seat control apparatus to:
determine the restoring mode as the specific operation mode when the identified previous operation mode is the target mode;
control the location of the seat such that the location of the seat corresponds to the restoring mode;
renew the operation mode of the seat to the restoring mode; and
store the renewed operation mode in the memory.

5. The seat control apparatus of claim 1, wherein the instructions, when executed by the controller, further cause the seat control apparatus to:
identify a reference operation mode corresponding to a case in which i) the previous operation mode is set to a stop mode and ii) the switch input is received when the seat is in a stop state and the identified previous operation mode is the stop mode when the switch input is received;
control the location of the seat such that the location of the seat corresponds to the reference operation mode;
renew the operation mode of the seat to the reference operation mode; and
store the renewed operation mode in the memory.

6. The seat control apparatus of claim 1, wherein the instructions, when executed by the controller, further cause the seat control apparatus to:
identify whether the seat is operated in the target mode or the restoring mode when the switch input is received; and
when the seat is operated in the target mode or the restoring mode
stop an operation of the seat,
renew the operation mode of the seat to a stop mode when the seat is stopped, and
store the renewed operation mode in the memory.

7. The seat control apparatus of claim 1, wherein the instructions, when executed by the controller, further cause the seat control apparatus to:
identify an operation state of the seat and a state of a host vehicle when the switch input is received;
identify whether the seat is operated in the target mode or the restoring mode when the operation state of the seat satisfies a first condition and the state of the host vehicle satisfies a second condition; and
when the seat is operated in the target mode or the restoring mode
stop an operation of the seat,
renew the operation mode of the seat to a stop mode when the seat is stopped, and
store the renewed operation mode in the memory.

8. The seat control apparatus of claim 7, wherein the instructions, when executed by the controller, further cause the seat control apparatus to:
identify whether the seat is operated in the target mode or the restoring mode when the operation state of the seat satisfies the first condition and the state of the host vehicle satisfies the second condition;
determine one of the target mode and the restoring mode as the specific operation mode based on the previous operation mode when the seat is operated in a post-emptive operation mode of the target mode and the restoring mode or is not operated;
control the location of the seat such that the location of the seat corresponds to the specific operation mode;
renew the operation mode of the seat to the specific operation mode; and
store the renewed operation mode in the memory.

9. The seat control apparatus of claim 7, wherein the instructions, when executed by the controller, cause the seat control apparatus to:
determine that the operation mode of the seat does not satisfy the first condition when the seat is operated in a pre-emptive operation mode of the target mode and the restoring mode; and
control the location of the seat continuously in the pre-emptive operation mode while neglecting the switch input.

10. The seat control apparatus of claim 7, wherein the instructions, when executed by the controller, cause the seat control apparatus to:
determine that the state of the host vehicle does not satisfy the second condition when a door corresponding to the seat is closed, a safety belt of the seat is in a fastened state, a passenger is seated on the seat, a gearshift of the host vehicle is not set to stage “P”, or a travel speed of the host vehicle is more than a specific speed; and
neglect the switch input and stop controlling the location of the seat.

11. A seat control method comprising:
receiving, by a controller, a switch input regarding a target mode, wherein the switch input is provided by a user through an input part;
identifying, by the controller, a previous operation mode of a seat;
determining, by the controller based on the previous operation mode, one of the target mode and a restoring mode as a specific operation mode;
controlling, by the controller, a location of the seat by using a driving part such that the location of the seat corresponds to the specific operation mode;
renewing, by the controller, an operation mode of the seat to the specific operation mode; and
storing, by the controller, the renewed operation mode in a memory.

12. The seat control method of claim 11, wherein the target mode includes at least one of a tip and slide mode, a walk-in slide mode, a backrest folding mode, a double folding mode, a stand-up mode, or a dive and go move, or any combination thereof.

13. The seat control method of claim 11, wherein:
determining one of the target mode and the restoring mode as the specific operation mode includes determining the target mode as the specific operation mode when the identified previous operation mode is the restoring mode;
controlling the location of the seat includes controlling the location of the seat such that the location of the seat corresponds to the target mode; and
renewing the operation mode of the seat includes renewing the operation mode of the seat to the target mode.

14. The seat control method of claim 11, wherein, when the identified previous operation mode is the target mode:
determining one of the target mode and the restoring mode as the specific operation mode includes determining the restoring mode as the specific operation mode;
controlling the location of the seat includes controlling the location of the seat such that the location of the seat corresponds to the restoring mode; and
renewing the operation mode of the seat includes renewing the operation mode of the seat to the restoring mode.

15. The seat control method of claim 11, further comprising:
identifying, by the controller, a reference operation mode corresponding to a case in which i) the previous operation mode is set to a stop mode and ii) the switch input is received when the seat is in a stop state and the identified previous operation mode is the stop mode when the switch input is received,
wherein controlling the location of the seat includes
controlling the location of the seat such that the location of the seat corresponds to the reference operation mode, and
renewing the operation mode of the seat includes renewing the operation mode of the seat to the reference operation mode.

16. The seat control method of claim 11, further comprising:
identifying, by the controller, whether the seat is operated in the target mode or the restoring mode when the switch input is received; and
when the seat is operated in the target mode or the restoring mode
stopping, by the controller, an operation of the seat,
renewing, by the controller, the operation mode of the seat to a stop mode when the seat is stopped, and
storing, by the controller, the renewed operation mode in the memory.

17. The seat control method of claim 11, further comprising:
identifying, by the controller, an operation state of the seat and a state of a host vehicle when the switch input is received;
identifying, by the controller, whether the seat is operated in the target mode or the restoring mode when the operation state of the seat satisfies a first condition and the state of the host vehicle satisfies a second condition; and
when the seat is operated in the target mode or the restoring mode
stopping, by the controller, an operation of the seat,
renewing, by the controller, the operation mode of the seat to a stop mode when the seat is stopped, and
storing the renewed operation mode in the memory.

18. The seat control method of claim 17, further comprising:
identifying, by the controller, whether the seat is operated in the target mode or the restoring mode when the operation state of the seat satisfies the first condition and the state of the host vehicle satisfies the second condition; and
determining, by the controller, one of the target mode and the restoring mode as the specific operation mode based on the previous operation mode when the seat is operated in a post-emptive operation mode of the target mode and the restoring mode or is not operated.

19. The seat control method of claim 17, further comprising:
determining, by the controller, that the operation mode of the seat does not satisfy the first condition when the seat is operated in a pre-emptive operation mode of the target mode and the restoring mode; and
controlling, by the controller, the location of the seat continuously in the pre-emptive operation mode while neglecting the switch input.

20. The seat control method of claim 17, further comprising:
determining, by the controller, that the state of the host vehicle does not satisfy the second condition when a door corresponding to the seat is closed, a safety belt of the seat is in a fastened state, a passenger is seated on the seat, a gearshift of the host vehicle is not set to stage “P”, or a travel speed of the host vehicle is more than a specific speed; and
neglecting, by the controller, the switch input and stopping controlling the location of the seat.
